(19) United States
(12) Patent Application Publication
(10) Pub. No.: US 2024/0268266 A1
(43) Pub. Date: Aug. 15, 2024

(54) AIR DELIVERY SIDE DISCHARGE WINDROWER

(71) Applicant: Loftness Specialized Farm Equipment, Inc., Hector, MN (US)

(72) Inventor: William C. Schafer, Hector, MN (US)

(21) Appl. No.: 18/402,923

(22) Filed: Jan. 3, 2024

Related U.S. Application Data
(63) Continuation-in-part of application No. 18/107,922, filed on Feb. 9, 2023.

(51) Int. Cl. A01D 41/12

(52) U.S. Cl. CPC A01D 41/1243

(57) ABSTRACT

Lower repair costs and more reliable operation are achieved by eliminating certain moving parts of a windrower and providing the windrower with a wing having at least one channel to redirect to one end of a machine stover entrained in an airflow ejected out the rear of a shredder.

### CROSS-REFERENCED TO RELATED APPLICATIONS

This application is a continuation-in-part of U.S. patent application Ser. No. 18/107,922 filed Feb. 9, 2023, and entitled “Air Delivery Side Discharge Windrower.”

### STATEMENT REGARDING FEDERALLY SPONSORED RESEARCH OR DEVELOPMENT

Not applicable

### BACKGROUND OF THE INVENTION

### I. Field of the Invention

The present invention relates to equipment used to improve the efficiency and profitability of agricultural operations. More specifically, the present invention relates to machines, specifically windrowers, used to collect stover into windrows for baling.

### II. Discussion of the Prior Art

Stover is the crop residue left in the field after harvesting grain. Stover includes the leaves and stalks of field crops, such as corn, sorghum, and other small grains, that are commonly left in a field after harvesting.

Farmers have found various uses for the stover gathered and removed from fields. Historically, stover has been primarily used for livestock bedding, but in some cases, it can also provide some nutritional value as part of livestock feed rations. More recently, stover has been used as a source of energy. Stover has been used as a source material in ethanol production. Stover may also be burned as a heat source or used directly in other forms of energy production.

Gathering and removing stover from a field typically involves several steps. First, the farmer must cut off the stover and reduce the particle size of the stover. This step is typically performed using a conventional crop shredder machine, which deposits the processed stover back on the ground. The second step is a raking operation. More specifically, the field is raked to deposit the processed stover into windrows. Third, a baler machine is used to harvest the processed stover as bales.

Today, many farmers perform the first and second steps outlined above in a single pass using a windrower machine. Windrower machines combine the operations of cutting off and reducing the particle size, with the operation of depositing the product into windrows in preparation for subsequent harvest using a baler.

Originally, windrow machines had a center discharge like the Model 180 and 240 Center Discharge Windrowers made by Loftness Specialized Equipment of Hector, Minnesota. As farming operations grew and farmers strived for greater efficiency, “End Discharge” windrowers, such as the Loftness Draper Windrowers, were developed. The advantage of the “End Discharge” system is that the product from the entire width of the cutting unit is delivered to one end of the machine. As such, when the farmer makes a full round, (traveling across the field in one direction and then returning in the opposite direction), the processed stover is deposited into groups of two immediately adjacent (co-mingled) windrows. Each such group of two such windrows may be harvested together by the baler in a single pass. This reduces by half the passes through a field that the baler must make.

Center discharge windrowers typically used air deflector panels to simply deflect or throw the material to the center. Prior efforts to design “End Discharge” windrowers that would use air deflector panels to deflect to the side of the machine proved unsuccessful. Trying to move all the processed stover to the end of the machine using air alone seemed to be impractical and consistently being able to do so seemed unachievable.

Equipment manufacturers responded by developing machines that incorporated some type of mechanical means to deliver the product to the end. These mechanical delivery means included employing either (i) a screw-type auger extending through a u-shaped trough, (ii) a steel pintle/drag chain with cross-slats, or (iii) as in the Loftness Draper Windrowers, a rubber belt conveyor. While these designs satisfactorily deliver processed stover to the end of the machines, and made it possible to deposit the processed stover into groups of two immediately adjacent (co-mingled) windrows, these prior art designs have certain disadvantages.

First mechanical designs using auger or drag chain or event belt conveyors have the potential to get clogged or plugged up in various crop conditions. Second, there is the potential for stover to get wrapped around the moving parts, causing added resistance, or possible damage to the machine. Third, maintenance costs in the form of labor and replacement parts, not to mention the costly downtime if the machine breaks down during the busy harvest schedule, make such mechanical designs less than ideal.

A real need, therefore, still exists for a simple and effective way, that overcomes the foregoing disadvantages, to move substantially all the stover processed by a shredder to the end of the machine and to deposit the processed stover into groups of two immediately adjacent (co-mingled) windrows.

### SUMMARY OF THE INVENTION

The present invention provides various improvements related to machines able, in a single pass, to (i) cut off and reduce the particle size of the stover, and (ii) deposit the processed stover back on the ground into groups of two immediately adjacent (co-mingled) windrows when the farmer makes a full round, i.e., traveling across the field in one direction and then returning. These improvements reduce maintenance costs and downtime, the risk of clogging, and the amount of dirt and other foreign materials that ultimately find their way into bales.

More specifically, the present invention relates to a windrower comprising a shredder having a plurality of spinning knives located in a housing having an elongate discharge opening. As the knives spin, they process the stover by chopping it into a fine particulate. The spinning of the knives also creates an airflow such that the air, and stover particulate entrained therein, exits the discharge opening. Windrowers made in accordance with the present invention further comprise a wing. The wing may have a stowed position and a deployed position. A pair of linkages and at least one linear hydraulic actuator may be used to move the wing between its stowed position and its deployed position. The wing, when in the wing's deployed position, is adapted to direct the airflow and the entrained stover to one side of the machine where the processed stover is deposited in a row on the ground. In the absence of the wing, the airflow generated by spinning knives would hurl the entrained material through a discharge opening, up into the air, scattering the processed stover behind the machine in a randomized fashion.

Directing substantially all the stover material from the discharge opening to one side of the machine is achieved by attaching the wing behind the discharge opening. The wing extends the full length of discharge opening and has a deposit end and a non-deposit end. When deployed, the wing's angle relative to the housing is such that the non-deposit end of the wing is closer to the housing than the deposit end of the wing.

Generally, a windrower made in accordance with the present invention will include a shredder and a wing. The shredder will have a housing surrounding a plurality of spinning knives adapted to process stover. This housing will have an elongate discharge opening through which the processed stover exits the housing entrained in a first airflow. The wing will have a non-deposit end, a deposit end, and a first baffle. The first baffle defines a first channel, an open proximal side, and an open deposit end side. The wing is adapted to be held in a deployed position in which the non-deposit end is closer to the housing than the deposit end, and said open proximal side is aligned with the elongate discharge opening. When the wing is in this deployed position, the first channel will receive processed stover entrained in a first airflow exiting the housing through the elongate discharge opening of the shredder and the first baffle will redirect the processed stover entrained in a first airflow along the first channel toward and through the open deposit end side. In certain embodiments, the first channel has a narrow section adjacent the non-deposit end, a wide section adjacent the deposit end, and a transition section between the narrow section and the wide section.

In some embodiments, the first baffle comprises a top plate having a first proximal end and a first distal end, a bottom plate having a second proximal end and a second distal end, and a transition extending between the first distal end and the second distal end. The bottom plate is typically dimensionally wider than the top plate. The open proximal side is generally beneath the top plate and proximal to the plane of the bottom plate.

In some embodiments, the wing is permanently fixed in its deployed position relative to the housing and discharge opening of the shredder. In other embodiments, the wing is adapted to move relative to the shredder between the deployed position and a stowed position. The wing is typically carried above the housing when the wing is in its stowed position. In these other embodiments, at least one linkage and at least one actuator adapted to move the wing relative to the shredder between the deployed position and a stowed position are typically provided. Various actuators, such as a linear hydraulic actuator, may be used.

Typically, the wing further comprises a second baffle at the deposit end. This second baffle is adapted to direct toward the ground processed stover exiting the first channel through the open deposit end side of the first baffle.

In alternative embodiments, the first baffle of the wing has a primary baffle assembly defining a first channel and a secondary baffle assembly defining a second channel. The primary baffle assembly comprises a top plate having a first proximal end and a first distal end, a bottom plate having a second proximal end and a second distal end, and a transition extending between the first distal and second distal end. When the wing is deployed, the first and second proximal ends are positioned closest to the housing such that the top plate, transition, and bottom plate form a first channel open toward the discharge opening of the shredder. The top plate resides above the top of the discharge opening and the second proximal end is below the bottom the discharge opening. The space between the first and second proximal ends is open (or has a large opening) and thus may be referred to as the “open proximal side” of the wing.

In embodiments wherein the first baffle has both a primary baffle assembly and a secondary baffle assembly, the secondary baffle assembly may be positioned within the first channel defined by the primary baffle assembly. When provided, the secondary baffle assembly extends the full length of the primary baffle assembly and descends from the top plate of the primary baffle assembly and then curves back toward, but is spaced by a gap from the transition and bottom plate. As so constructed, secondary baffle assembly, together with the primary baffle assembly, form a secondary channel open at the bottom and extending the length of the wing. Both the primary and secondary channels are also open at the deposit end of the wing.

As noted above, the wing may include a second baffle. This second baffle may comprise a tertiary baffle assembly adjacent to the deposit end opening of the first channel when only a first channel is present and of the deposit end openings of the first and second channels when both such channels are present. The tertiary baffle assembly may simply be a plate or series of teeth coupled to the wing and hanging down adjacent to and spaced from the deposit end opening(s) of the channel(s).

When a windrower made in accordance with the present invention is used, the wing is deployed. As the knives of the shredder spin, an airflow is created up and out through the discharge opening of the housing into the primary channel and, if present, the secondary channel of the wing. The overall angle and shape of the first channel serves to redirect virtually all this airflow toward and out the deposit end opening of the first channel by causes this air to move in a rotational and longitudinal screw-like fashion through the first channel to the discharge end of the wing. When a secondary channel is also provided, a first airflow entering the wing from the discharge opening is divided by the primary and secondary baffle assemblies into two distinct second and third airflows. The second airflow is deflected and directed along the first channel to and out the discharge end. The third airflow, comprising air entering the secondary channel through the gap is likewise deflected and directed along the second channel to and out the discharge end. The shape of the second channel also causes this air to move in a rotational and longitudinal screw-like fashion through the second channel to the discharge end of the wing. As the windrower moves through a field, the knives draw the stover into the housing, chop it into a fine particulate, and entrain the processed stover particulate into the air flow. As such, substantially all the processed stover travels into the first channel (and when the second channel is present into the first and second channels) and then through the first channel (and second channel) to and out the opening(s) of the channel(s) at the deposit end of the wing. Material striking the tertiary baffle assembly of the second baffle after exiting the first channel (and if present the second channel) at the discharge end of the wing then falls to the ground in an organized row.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is a front view of a windrowing machine made in accordance with the present invention.

FIG. 2 is a back view of the windrowing machine of FIG. 1.

FIG. 3 is a bottom view of the windrowing machine of FIG. 1.

FIG. 4 is a top view of the windrowing machine of FIG. 1.

FIG. 5 is a left side view of the windrowing machine of FIG. 1.

FIG. 6 is a right side view of the windrowing machine of FIG. 1.

FIG. 7 is a right side view of the windrowing machine of FIG. 1 with the tertiary baffle removed.

FIGS. 8 through 18 are a collection of isometric views of the windrowing machine for FIG. 1 from various perspectives with the of the wing in its deployed position.

FIGS. 17 through 20 are a collection of isometric views of the windrowing machine of FIG. 1 with the wing in its stowed position.

FIGS. 21 through 23 illustrate the flow of air, and processed stover entrained in the air, to and across the wing through a secondary channel.

FIGS. 24 through 26 illustrate an alternative embodiment of the wing wherein the first baffle defines a single channel through which stover is carried to one side of the windrowing machine.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

The windrower 1 shown in the drawings has two main assemblies, specifically a shredder 2 and wing 3. Shredder 2 sits on a frame selectively supported by two independent sets of wheels. The first independent set of wheels comprises wheels 12 and 13 which are deployed to permit the windrower 1 to be towed using a first hitch assembly 14. The wheels 12/13 and hitch assembly 14 are typically employed when towing the windrower 1 along roads and highways. The second set of wheels comprises wheels 16, 17, 18 and 19. Wheels 16 through 19 are typically used when towing the windrower 1 using a second hitch assembly 20. The wheels 16 thorough 19 and the second hitch assembly 20 are typically employed when towing the windrower 1 across a farm field to perform a windrowing operation.

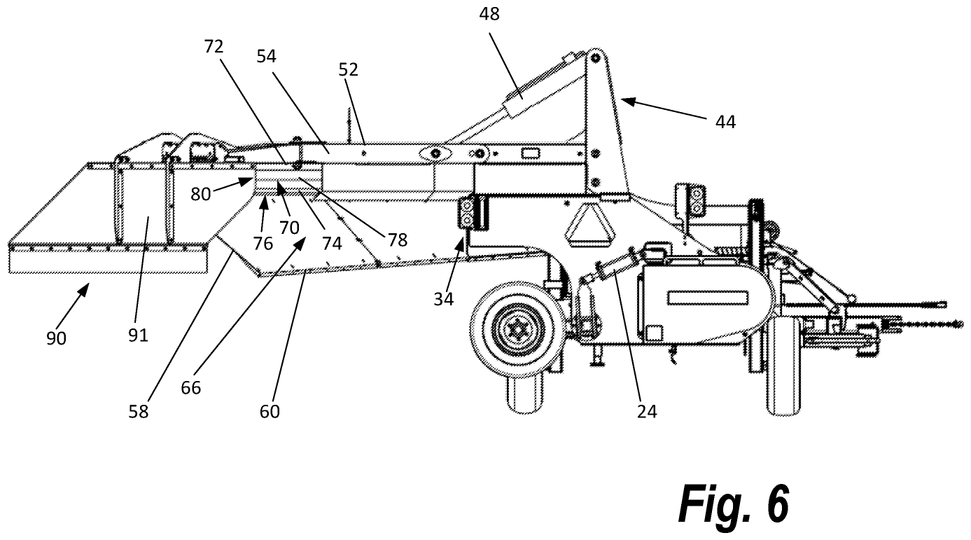

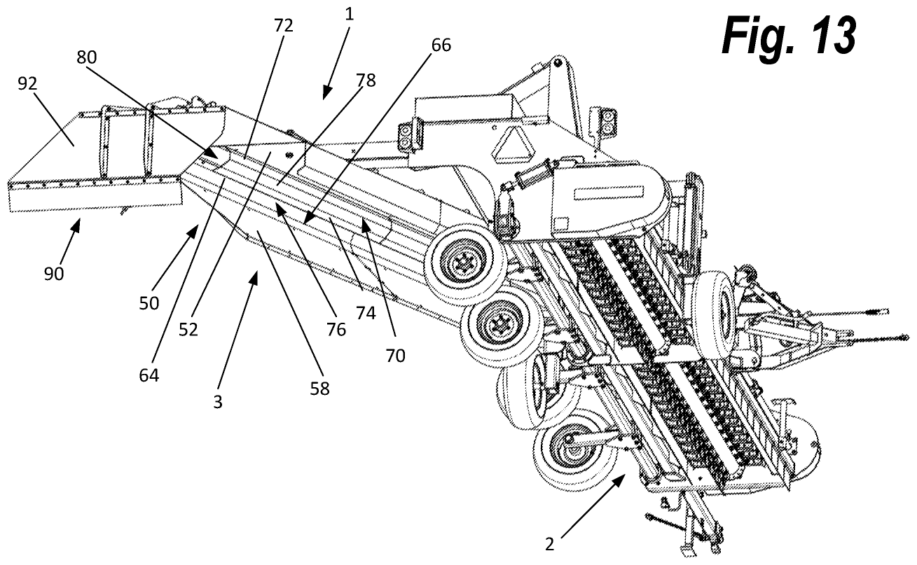

As illustrates, for example in FIG. 6, the wheels 16 through 19 are mounted relative to the frame 10 by tag axle linkages 22 that are each coupled to an axle 23 rotated by at least one linear hydraulic actuator 24 to move the wheels 16 through 19 between a retracted position shown in FIG. 6 and a deployed, ground engaging position shown in FIG. 13. When wheels 16 through 19 are in their deployed, ground engaging position, wheels 12 and 13 are lifted off the ground and the windrower is supported only by wheels 16 through 19. When wheels 16 through 19 are in their retracted position, the windrower 1 is supported by wheels 12 and 13 which then engage the ground.

Frame 10 supports housing 26. Mounted within the housing are a plurality of rotary blade assemblies 28 each coupled to, and for rotation with, an axle 30 extending substantially the entire length of the frame. The shredder 2 also includes a power takeoff, gearbox and banded belt assembly which deliver rotational power to the axle 30 and rotary blade assemblies 28. Rotary speeds of the blade assemblies 28 range from about 1450 to 2000 revolutions per minute at about 280 horsepower.

Each rotary blade assembly 28 includes a plurality of blades 32. The blades 32 perform three functions as they are rotated. First, blades 32 pull and sever stover from the ground. Second, blades 32 process the stover into a fine particulate. Third, blades 32 create a first airflow into which the processed stover is entrained. This first airflow, and the processed stover entrained therein, is ejected from the housing through an elongate discharge opening 34 at the rear of the housing 26 and extending substantially along its entire length. Absent the presence of the wing 3, the airflow would scatter the processed stover in a randomized fashion behind the shredder 2 as it is pulled across the field by a tractor (not shown) coupled to the second hitch assembly and power takeoff.

One objective of the present invention is to prevent scattering of the processed stover and, instead, deposit the processed stover in a windrow adjacent a side of the windrower 1. This objective is met by employing a wing 3 constructed, and coupled to the frame 10 and housing 26, as discussed below.

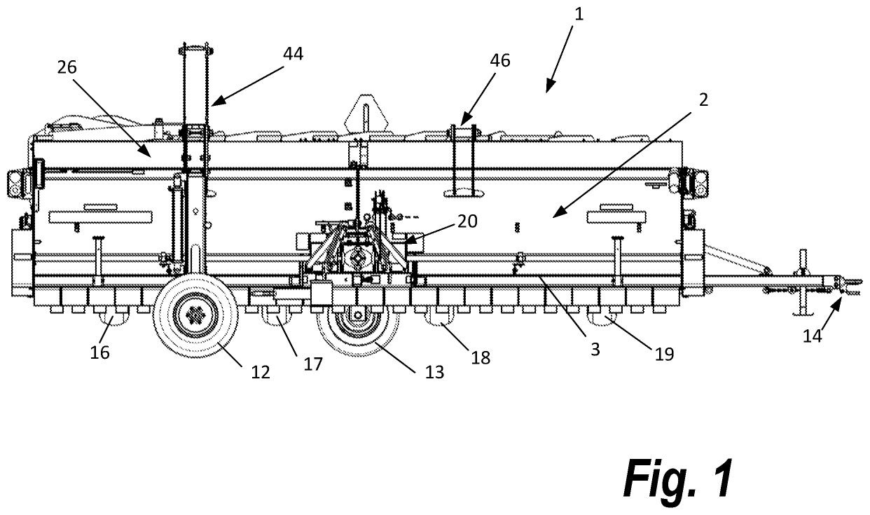

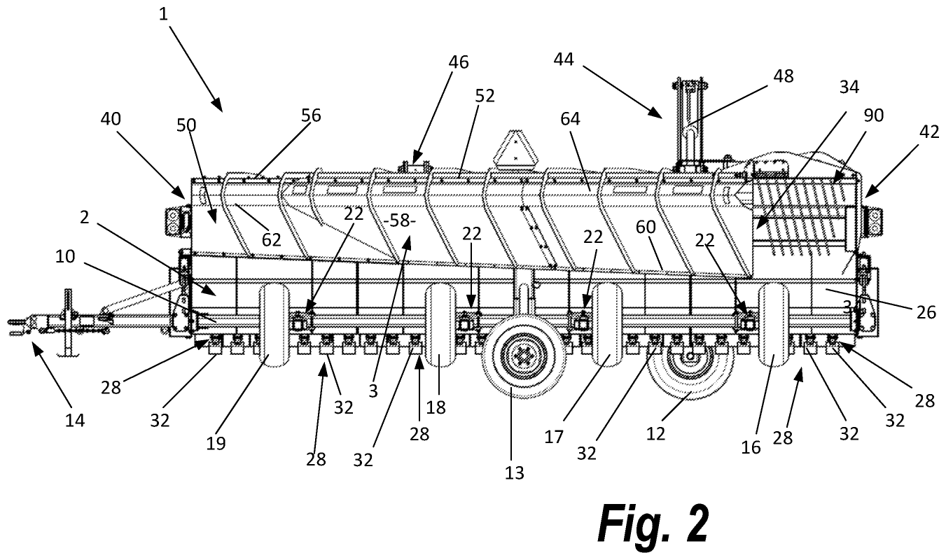

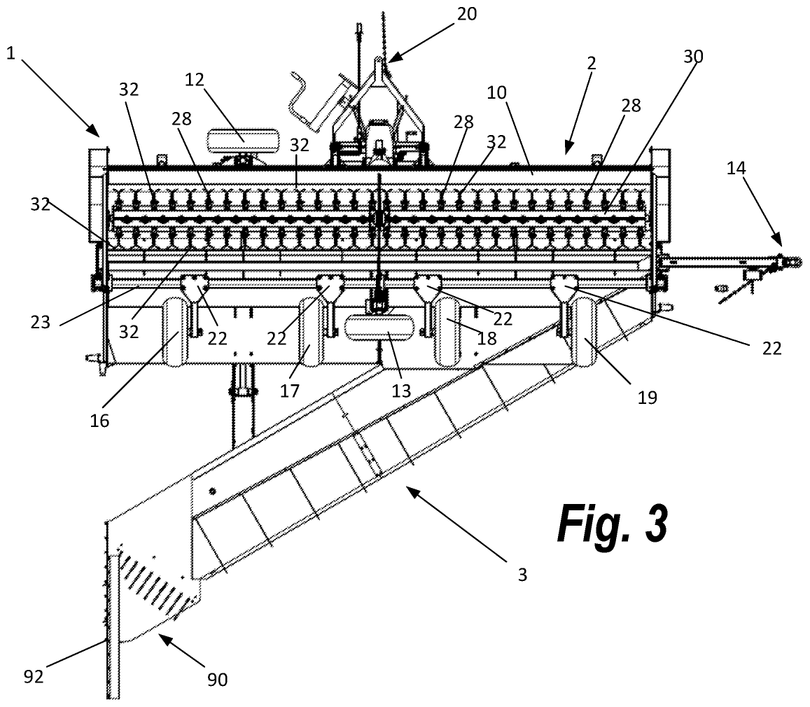

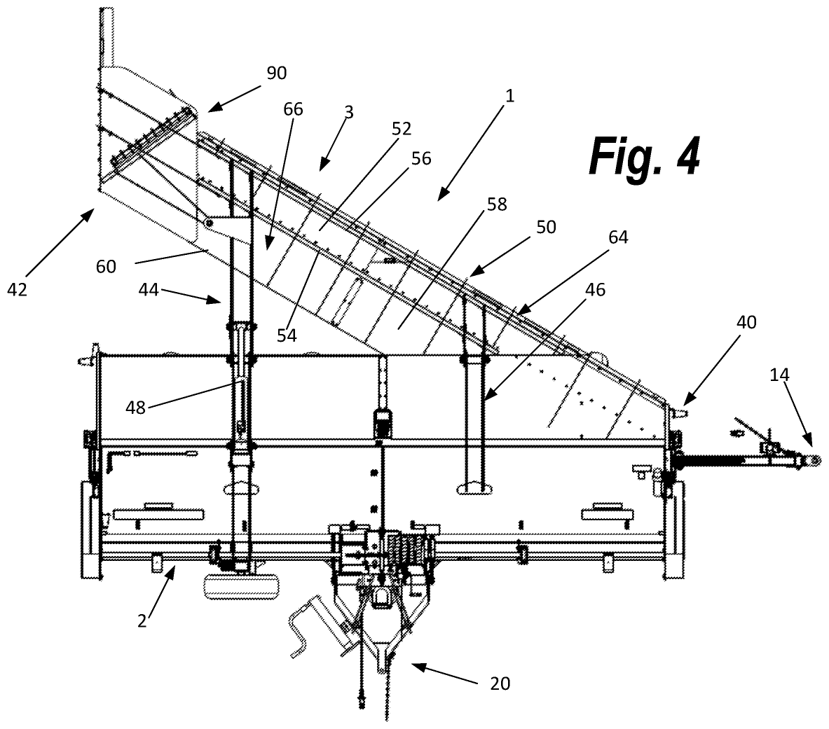

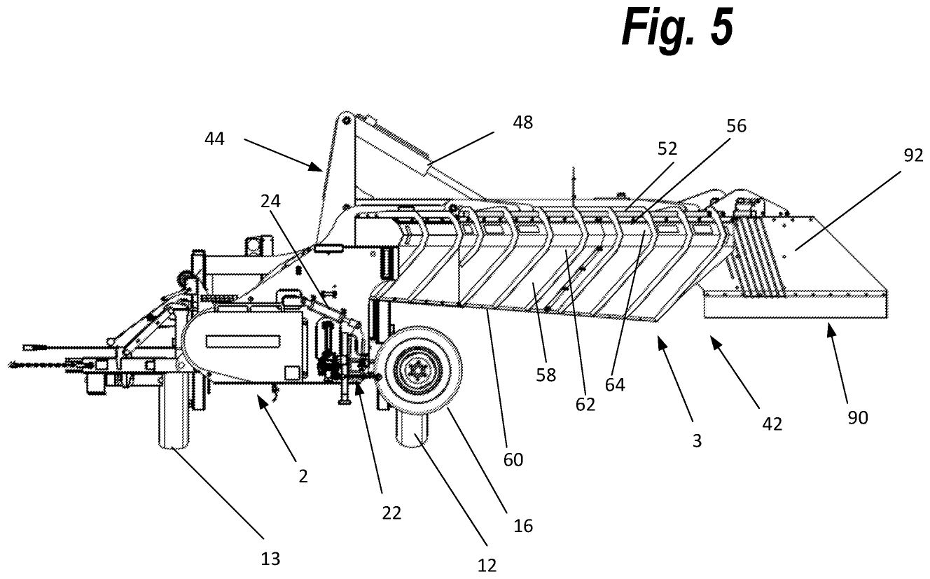

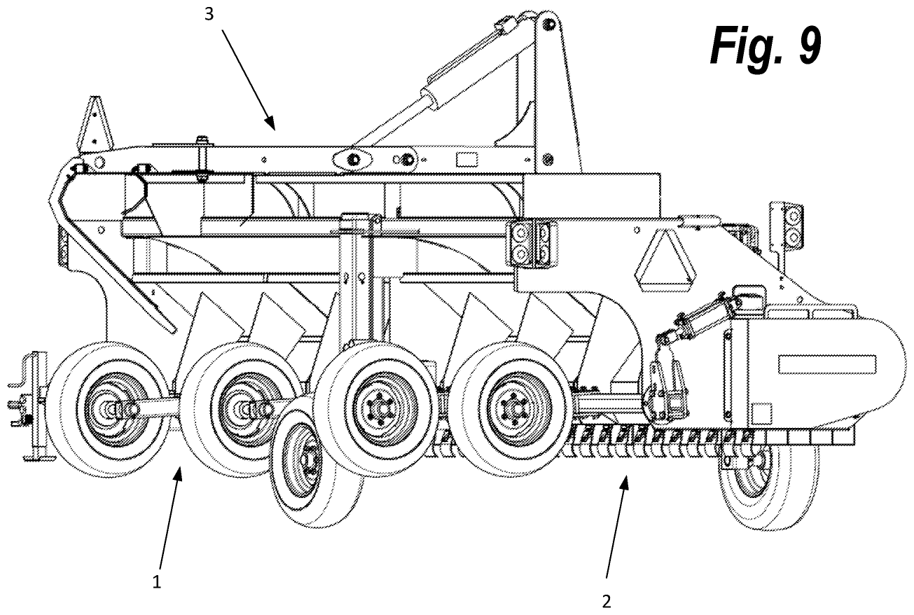

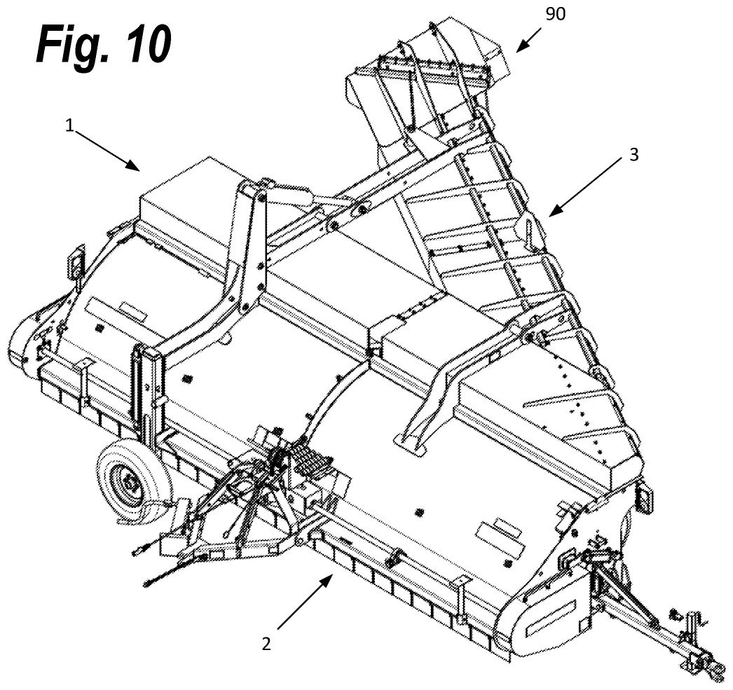

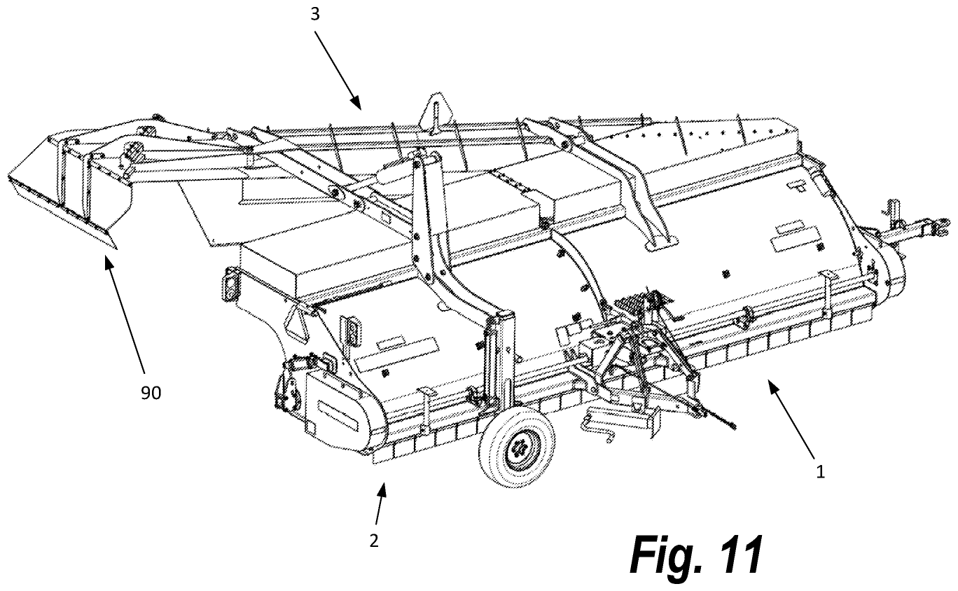

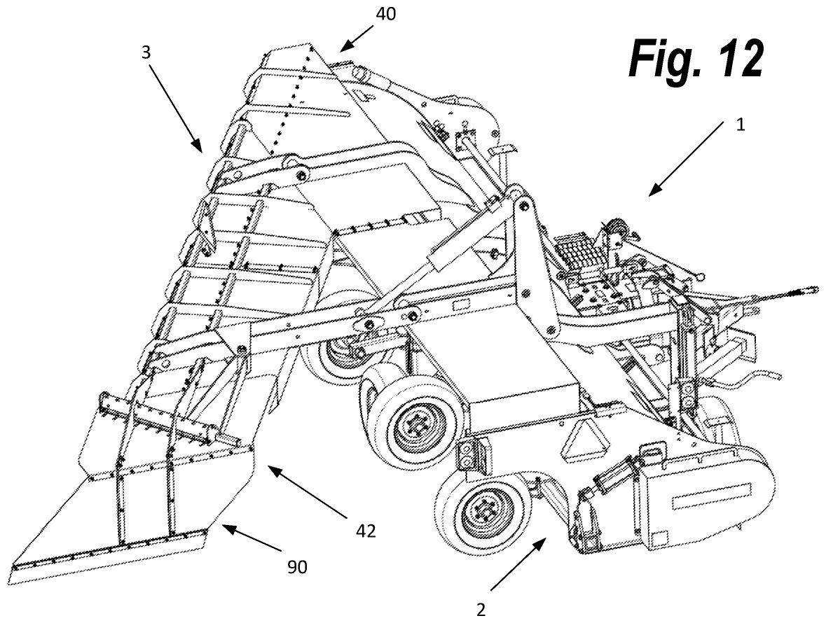

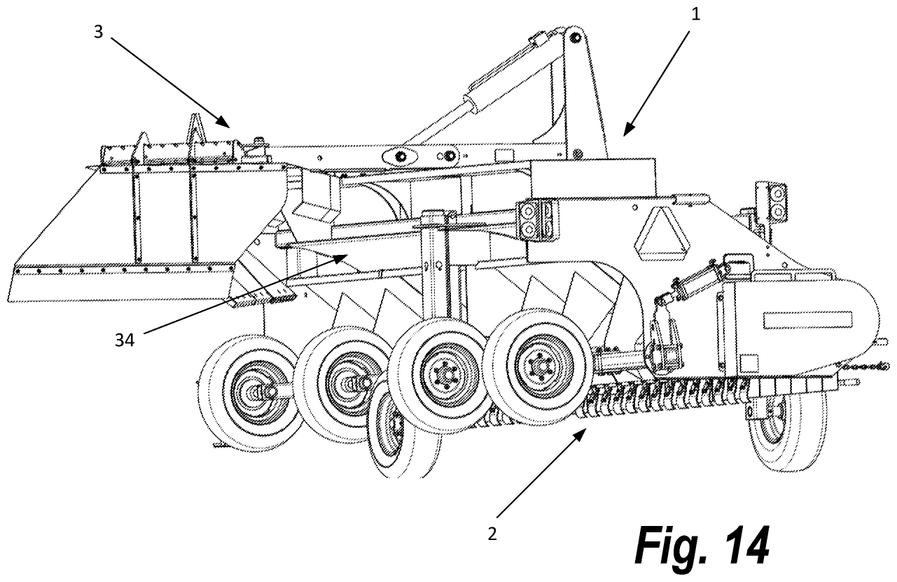

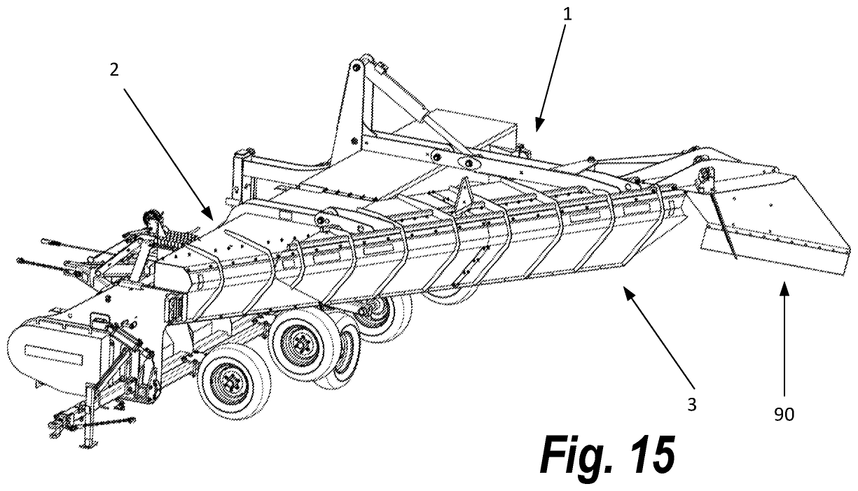

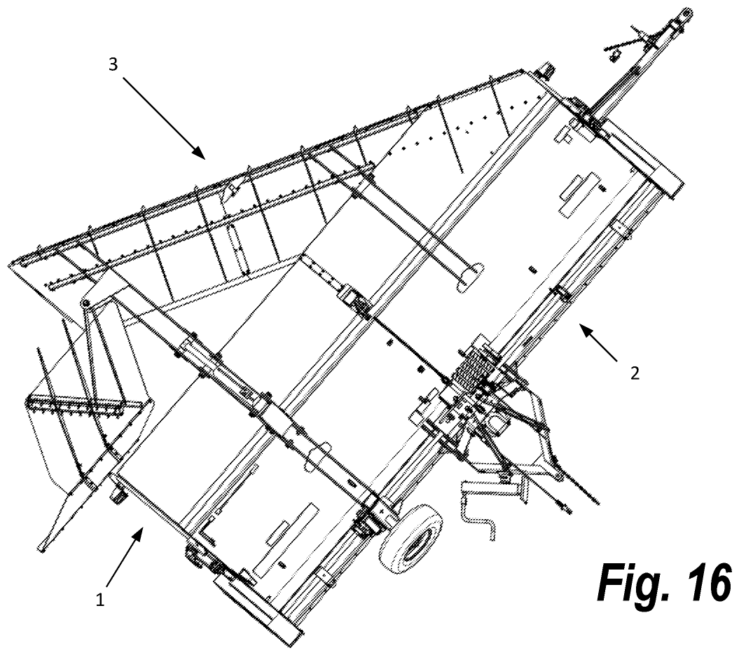

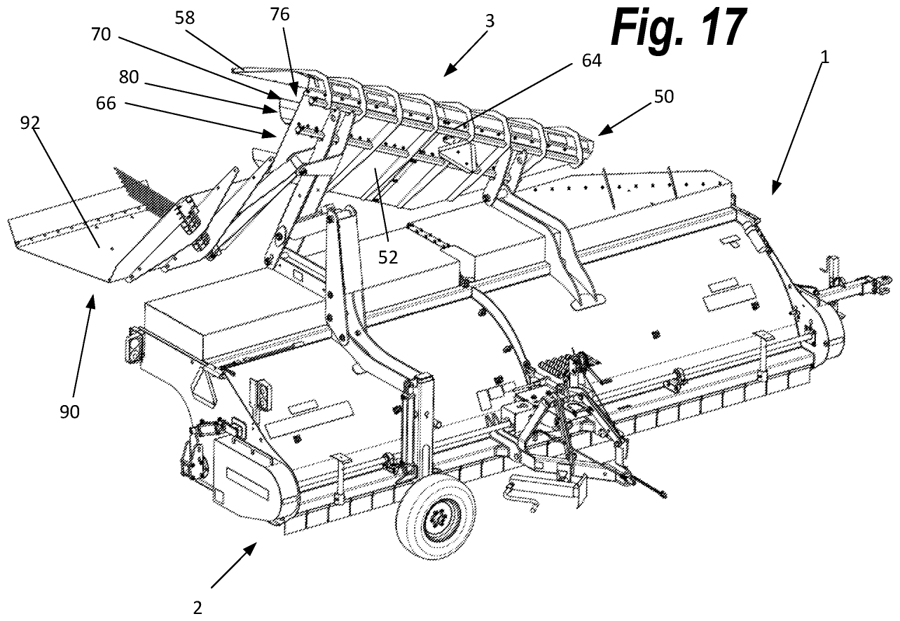

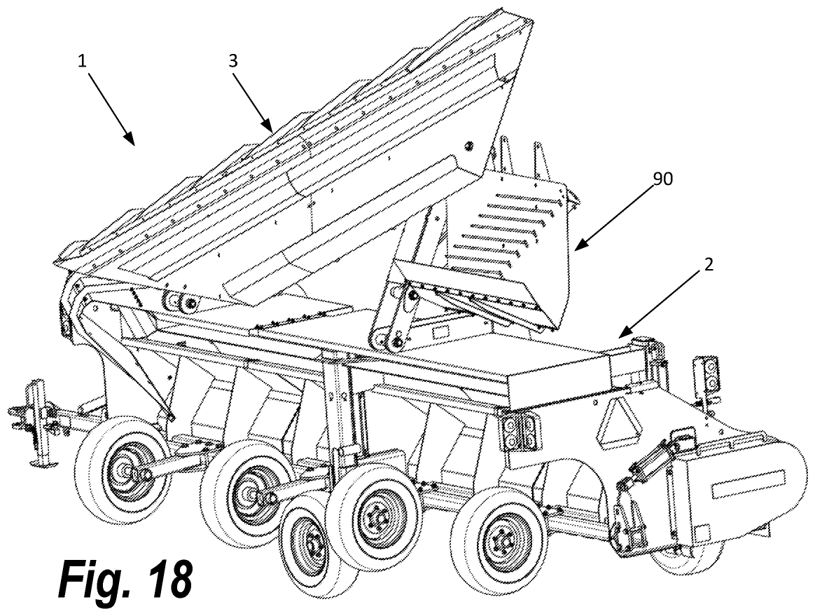

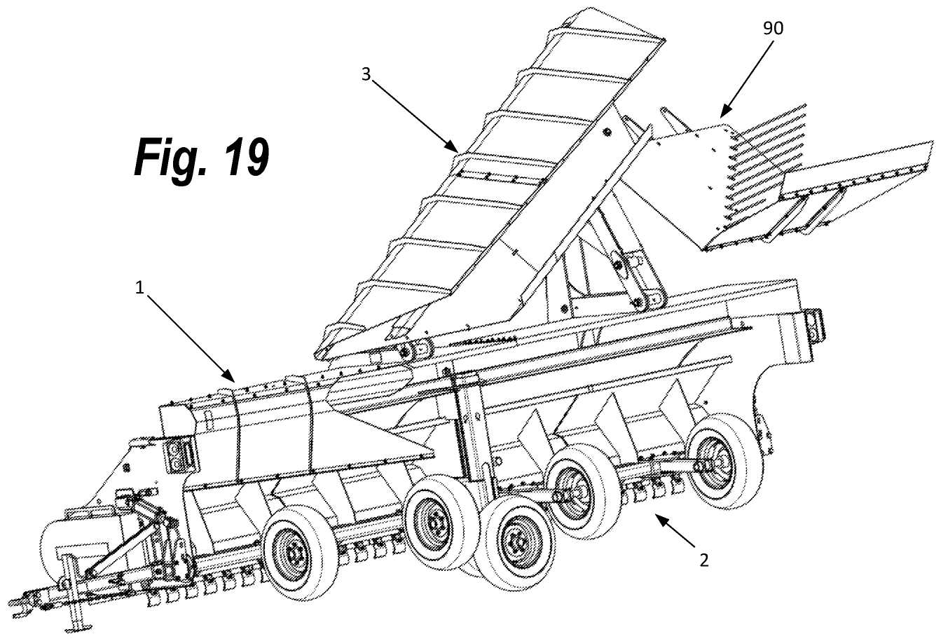

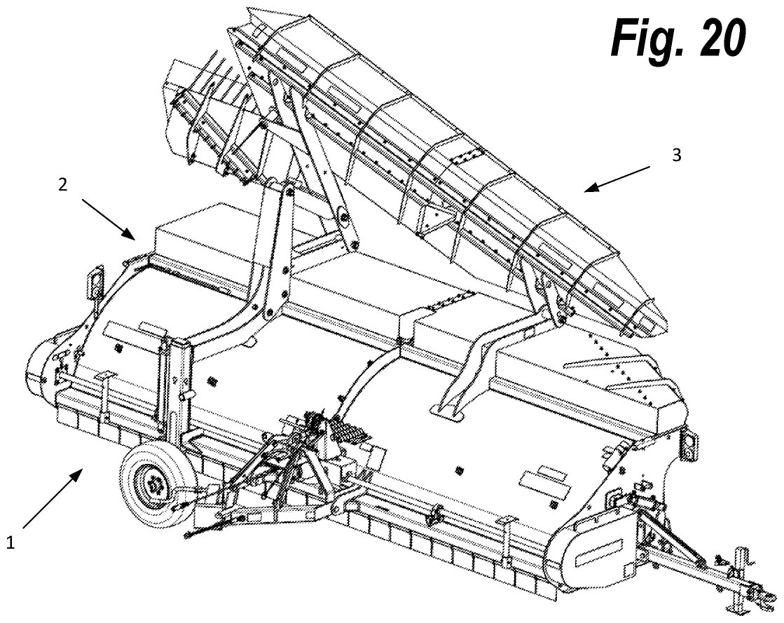

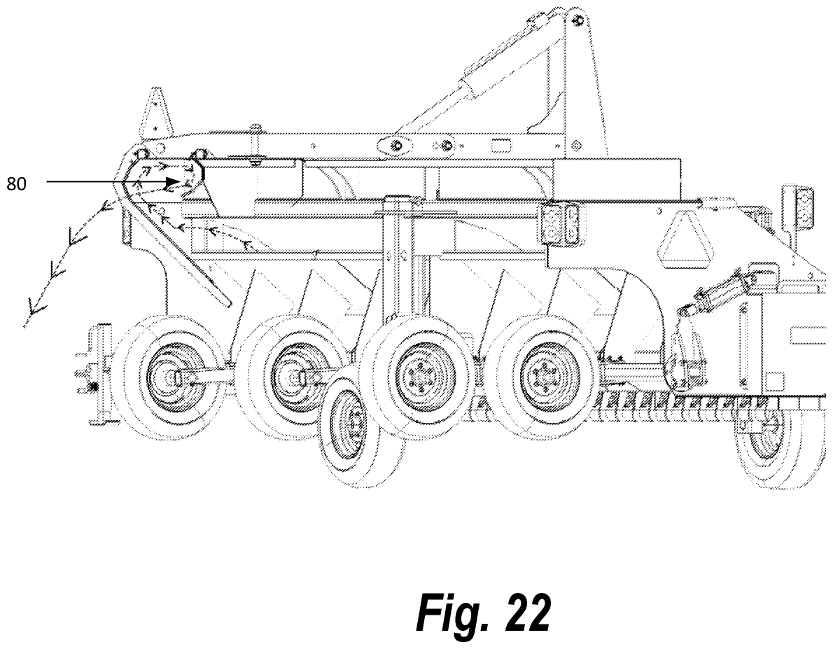

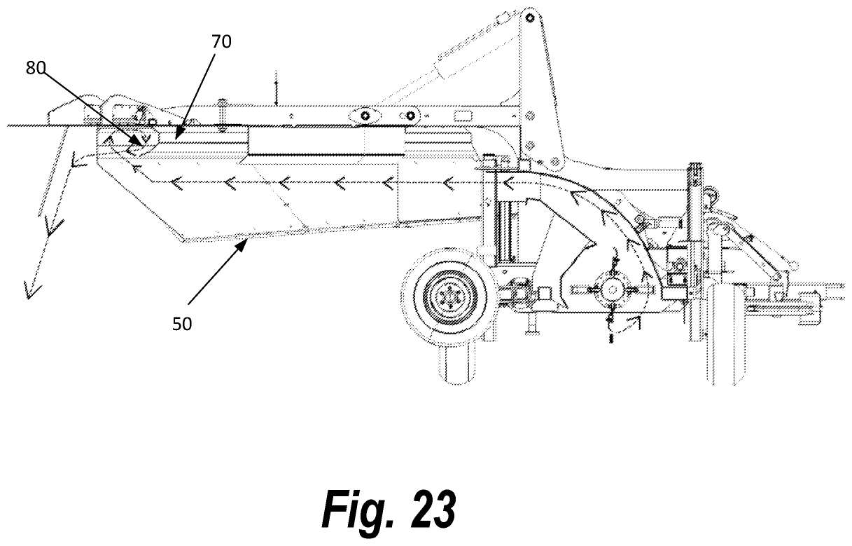

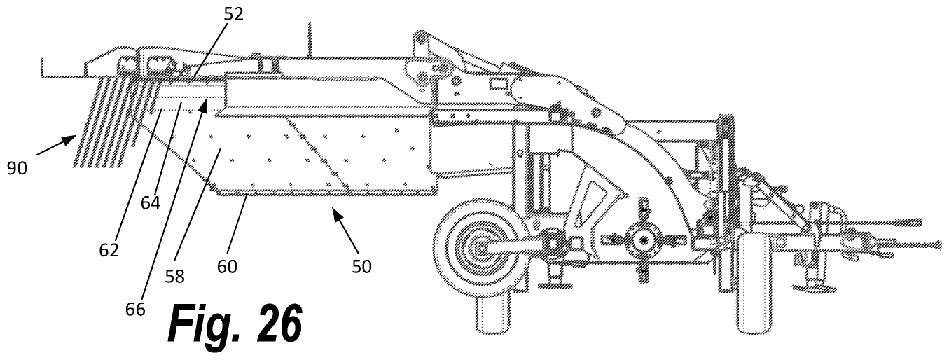

Wing 3 extends between a non-deposit end 40 and a deposit end 42. The wing 3 has a deployed position relative to the housing 26 shown in FIGS. 1 through 16, 21 through 22, and 25 through 26. Wing 3 may also have a stowed position illustrated in FIGS. 17 through 20, and 24. When windrower 1 is being used to process stover and organize the processed stover into rows, wing 3 is in its deployed position. When the windrower is being prepared for storage or transport via a road or highway, the wing 3 may be moved to its stowed position. Moving wing 3 between its deployed and stowed positions may be facilitated by a first linkage 44 and a second linkage 46 coupling the wing 3 to the housing. A linear hydraulic actuator 48 coupled between two elements of linkage 46 is shown in several of the figures. Extending linear hydraulic actuator 48 moves the wing to the wing's deployed position and retraction of the linear hydraulic actuator 48 places the wing in the wing's stowed position. Other mechanisms, such as a ratchet assembly or lever, may be employed in conjunction with the first and second linkages 44 and 46 to move wing 3 between the stowed and deployed positions. The linear hydraulic actuator or other such mechanism may be used to hold wing 3 in either of its two positions. Separate locks, not shown, may also be employed to hold wing 3 in either the wing's deployed or stowed position.

When wing 3 is in its deployed position, the non-deposit end 40 of the wing sits closer to the housing 26 than the deposit end 42 of wing 3. In other words, wing 3 is angled relative to the housing 26 and discharge opening 34. This angle causes processed stover to eject from the elongate discharge opening to engage the wing and then move along the wing toward the discharge end. The angle of the wing alone, however, is not enough to successfully deposit the processed stover in a windrow adjacent the windrower 1. Wing 3 is constructed with important design features that permit this to occur.

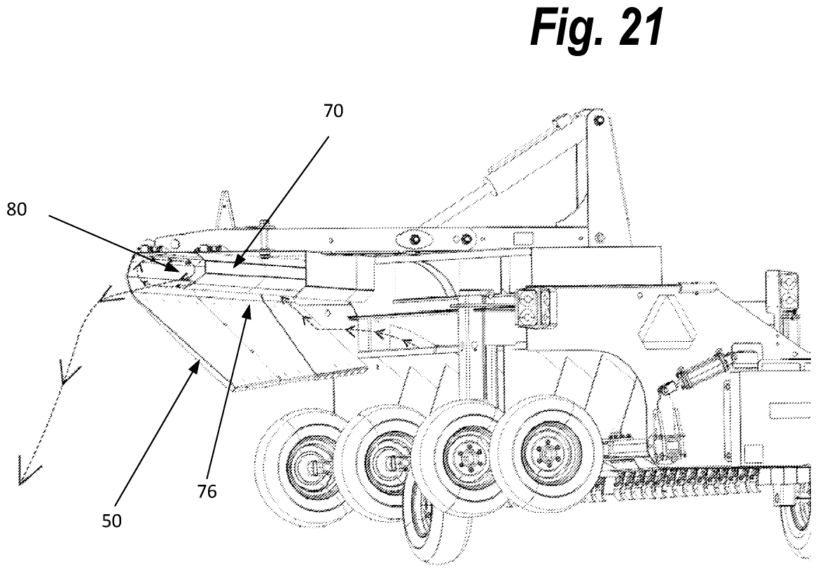

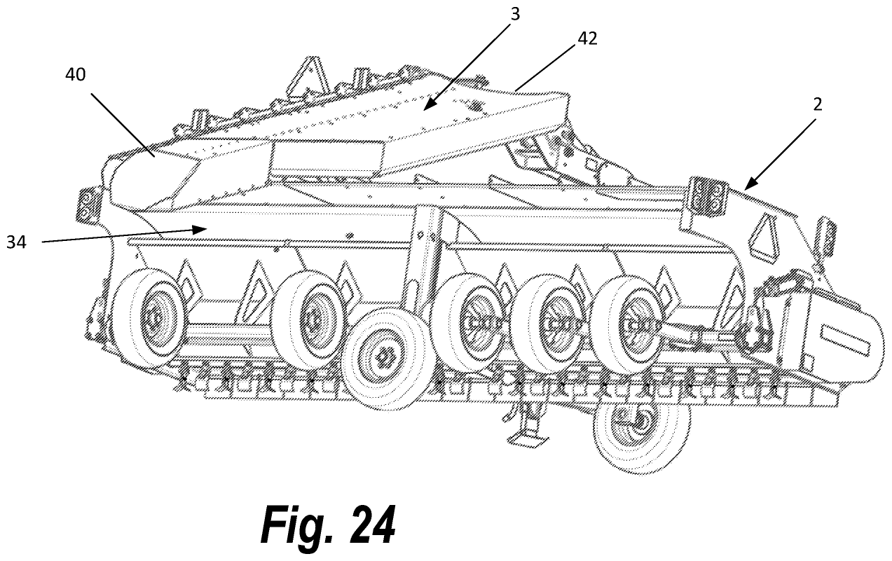

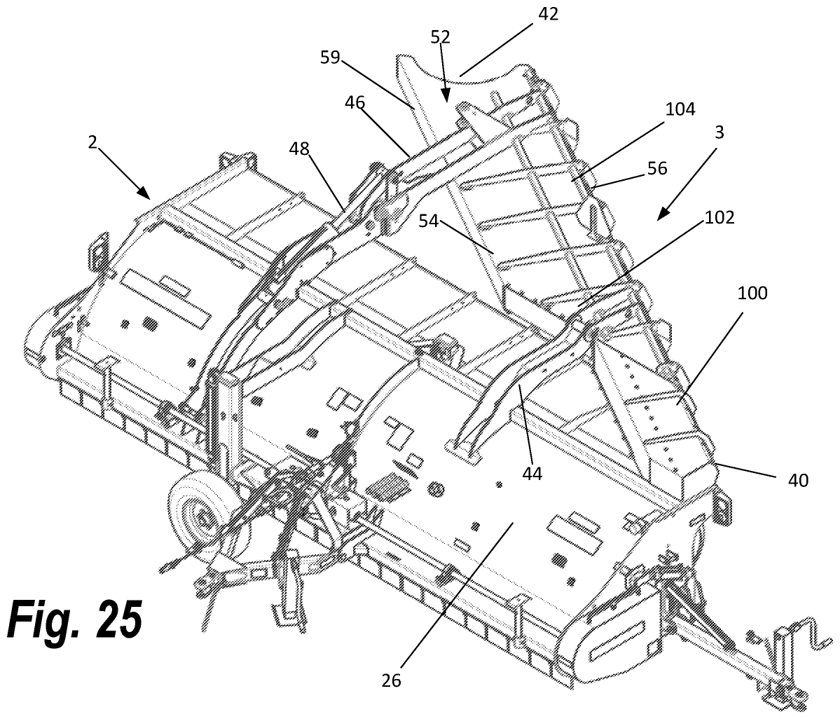

Specifically, wing 3 has a first baffle. As shown, for example, in FIG. 21, the first baffle comprises a primary baffle assembly 50 and a secondary baffle assembly 70. As shown in FIGS. 24 through 25, the first baffle may only have a single, i.e., primary, baffle assembly. In either case, the primary baffle assembly 50 comprises a top plate 52 having a first proximal end 54 and a first distal end 56. The primary baffle assembly 50 further comprises a bottom plate 58 having a second proximal end 60 and a second distal end 62. A transition 64 extends between and couples the distal ends 56 and 62 so that the top plate 52 and the bottom plate are angled relative to each other creating a primary channel 66 facing the elongate discharge opening 34. As shown in various figures, the top plate 52 resides above the elongate discharge opening 34 and the bottom plate 58 extends below the bottom of the elongate discharge opening 34 when wing 3 is in the deployed position. The primary channel may be closed at the non-deposit end 40 of wing 3 but is open toward the elongate discharge opening 34 and at the deposit end 42 of wing 3. More specifically, between the proximal end 54 and the proximal end 60 is an open proximal side. The proximal open side may be fully open or may include a short proximal panel 59 descending a short distance from the proximal end 54 of the top plate 52.

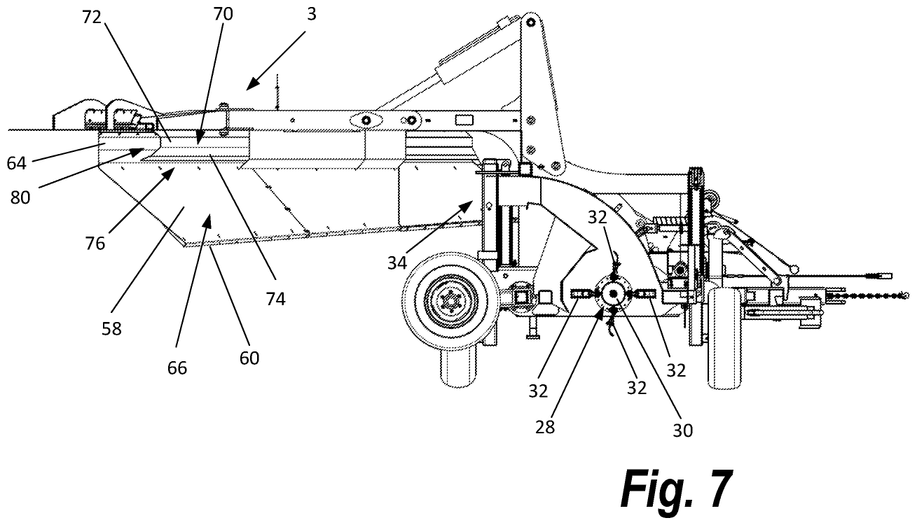

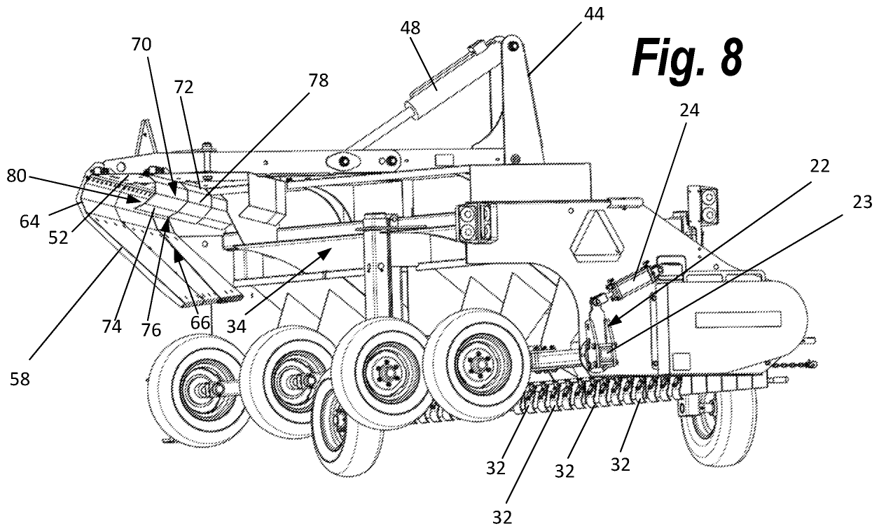

When the first baffle comprises a secondary baffle assembly 70, the secondary baffle assembly 70 resides in the top portion of the primary channel 66. As shown in FIGS. 7 and 8, the secondary baffle assembly 70 comprises a first wall portion 72 coupled to and descending from the top plate 52 and a second wall portion 74 extending toward the transition 64 and bottom plate 58 near where they meet. A space or gap 76 is left between the second wall portion and the transition 64 and bottom plate 58. The first wall portion 72 and second wall portion 74 are joined together by a second transition portion 78 which may be continuously curved or bent one or more times to provide an angular transition between the first wall portion 72 descending from the top plate 52 and second wall portion 74 extending away from the elongate discharge opening 34 toward the bottom plate 58 and transition 64. As so constructed, the primary baffle assembly 50 and secondary baffle assembly 70 of the first baffle cooperate to form a secondary channel 80 open along its length (see gap 76) and at the deposit end 42 of wing 3.

In some embodiments of the invention, wing 3 may also include a second baffle comprising a tertiary baffle assembly 90 adjacent the open ends of the primary channel 66 and secondary channel 80 at the deposit end 42 of the wing 3. The tertiary baffle assembly 90 operates to deflect to the ground the processed stover exiting the primary channel 66 and secondary channel 80 through their open ends at the deposit end 42 of wing 3. The tertiary baffle assembly may comprise a single descending panel 92 or a plurality of such panels or rods. Employing rods or a plurality of panels allows air to pass through as the stover is directed to the ground.

When the windrower 1 is in use, the wing 3 is placed in its deployed position and the windrower 1 is hitched to a tractor and the power takeoff is mechanically coupled to the tractor's engine and engaged causing the rotary blade assemblies 28 to spin. As the tractor pulls the windrower 1 through a farm field, the blades 32 pull the stover left in the field into the housing 26, cut the stover into particles (i.e., processed stover) and create a first airflow in which the processed stover becomes entrained. This first airflow and the entrained processed stover exits the housing 26 through the elongate discharge opening 34 and then is caught by the wing 3.

When wing 3 has a single channel, wing 3 receives the processed stover entrained in a first airflow exiting the housing through the elongate discharge opening and the first baffle redirects the processed stover entrained in this first airflow along this channel toward and through the open deposit end side. Flow through this channel is both rotational and longitudinal, in a screw-like fashion, toward and out the deposit end 42 of the wing 72. The continuous influx of air into the first channel along the length of the open proximal side of the first channel acts as an air curtain. When a second baffle comprising tertiary baffle assembly 90 is employed, processed stover exiting through the open ends of the first channel 66 at the deposit end 42 of the wing 3 is deflected to the ground by the tertiary baffle assembly 90 to form a windrow.

If wing 3 has two channels, the wing divides the first airflow into two distinct second and third airflows, specifically a second airflow created in the primary (first) channel and a third airflow created in the secondary (second) channel. The shape of the primary baffle assembly 50 redirects the first airflow such that some of this airflow is directed along the primary channel 66 toward the deposit end 42 of the wing 3 and a substantial portion (most) of this airflow is directed into the secondary channel 80 through the gap 76. The secondary baffle assembly 70 causes the air entering the secondary channel 80 to flow both in a rotational and longitudinal screw-like fashion toward and out the deposit end 42 of the wing 72. The continuous influx of air through the gap acts as an air curtain. When a tertiary baffle assembly 90 is employed, processed stover exiting through the open ends of the primary channel 66 and secondary channel 80 at the deposit end 42 of the wing 3 is deflected to the ground by the tertiary baffle assembly 90 to form a windrow.

In some embodiments, the top plate 52 of wing 3 will be generally rectangular. Alternatively, and as shown in FIGS. 24 through 26, the top plate may be shaped so the wing has a narrower section 100 toward the non-deposit end 40, a wider section 104 toward the deposit end 42, and a transition section 102 between sections 100 and 104.

In some embodiments, when the windrower 1 is not in use or needs to be transported over a public roadway, the wing 3 may be moved to a stowed position shown in FIGS. 17 through 20. Additionally, the tractor is moved from hitch assembly 20 to hitch assembly 14, and the tag axle linkages 22 are operated by the linear hydraulic actuator 24 to retract the second set of wheels 16-19 so that the windrower 1 is supported by the wheels 12 and 13.

Various additional advantages of the present invention should be apparent to one of ordinary skill in the art from the foregoing detailed description and the accompanying drawings. This disclosure is therefore not intended to be limiting.

1. A windrower comprising:
a. a shredder having a housing surrounding a plurality of spinning knives adapted to process stover, said housing having an elongate discharge opening through which the processed stover exits the housing entrained in a first airflow; and
b. a wing having a non-deposit end, a deposit end, and a first baffle, said first baffle defining a first channel, an open proximal side and an open deposit end side, wherein said wing is adapted to be held in a deployed position in which the non-deposit end is closer to the housing than the deposit end, and said open proximal side is aligned with the elongate discharge opening so that the first channel receives the processed stover entrained in a first airflow exiting the housing through the elongate discharge opening and the first baffle redirects the processed stover entrained in a first airflow along the first channel toward and through the open deposit end side.

2. The windrower of claim 1 wherein said wing has a narrow section adjacent the non-deposit end, a wide section adjacent the deposit end, and a transition section between the narrow section and the wide section.

3. The windrower of claim 1 wherein said first baffle comprises a top plate having a first proximal end and a first distal end, a bottom plate having a second proximal end and a second distal end, and a transition extending between the first distal end and the second distal end, wherein the bottom plate is dimensionally wider than the top plate.

4. The windrower of claim 1 wherein said wing is adapted to move relative to the shredder between the deployed position and a stowed position.

5. The windrower of claim 1 further comprising at least one linkage and at least one actuator adapted to move the wing relative to the shredder between the deployed position and a stowed position.

6. The windrower of claim 1 wherein the wing comprising a second baffle at the deposit end, said second baffle adapted to direct toward the ground processed stover exiting said first channel through the open deposit end side.

7. A wing for a windrower, said wing comprising a non-deposit end, a deposit end, and a first baffle, said first baffle defining a first channel, an open proximal side and an open deposit end side, wherein said wing is adapted to be held in a deployed position in which the non-deposit end is closer to a housing of a shredder than the deposit end, and said open proximal side is aligned with an elongate discharge opening of the housing of the shredder so that the first channel receives processed stover entrained in a first airflow exiting the housing through the elongate discharge opening and the first baffle redirects the processed stover entrained in the first airflow along the first channel toward and through the open deposit end side.

8. The wing of claim 7 further comprising a second baffle at the deposit end of the wing, said second baffle adapted to direct toward the ground processed stover exiting said first channel through the open deposit end side.

9. The wing of claim 7 wherein said first baffle comprises a top plate having a first proximal end and a first distal end, a bottom plate having a second proximal end and a second distal end and a transition extending between the first distal end and second distal end, wherein the bottom plate is dimensionally wider than the top plate.

10. The wing of claim 7 further comprising a second channel formed by the first baffle.

11. The wing of claim 7 wherein said wing is adapted to move relative to the shredder between a stowed position above the housing and the deployed position.

12. The wing of claim 7 further comprising at least one linkage and at least one actuator adapted to move the wing relative to the shredder between the deployed position and a stowed position.

13. The wing of claim 7 wherein said wing has a narrow section adjacent the non-deposit end, a wide section adjacent the deposit end, and a transition section between the narrow section and the wide section.

14. A wing for a windrower, said wing comprising a non-deposit end, a deposit end, and a first baffle, said first baffle defining a first channel and a second channel, an open proximal side and an open deposit end side, wherein said wing is adapted to be held in a deployed position in which the non-deposit end is closer to a housing of a shedder than the deposit end, and said open proximal side is aligned with an elongate discharge opening of the housing of the shredder so that the first channel and the second channel receive processed stover entrained in a first airflow exiting the housing through the elongate discharge opening and the first baffle redirects the processed stover entrained in a first airflow along the first channel and the second channel toward and through the open deposit end side.

15. The wing of claim 14 further comprising a second baffle at the deposit end of the wing, said second baffle adapted to direct toward the ground processed stover exiting the first channel and the second channel through the open deposit end side.

16. The wing of claim 14 wherein said wing has a narrow section adjacent the non-deposit end, a wide section adjacent the deposit end, and a transition section between the narrow section and the wide section.

17. The wing of claim 14 wherein said wing is adapted to move relative to the shredder between a stowed position and the deployed position.

18. The wing of claim 14 comprising a linkage and an actuator adapted to move the wing relative to the shredder between the deployed position and a stowed position.

19. The wing of claim 18 wherein the actuator is a linear hydraulic actuator.

20. The wing of claim 14 wherein the first baffle comprises (a) a top plate having a first proximal end and a first distal end, a bottom plate having a second proximal end and a second distal end and a transition extending between the first distal and second distal end to define the first channel, and (b) the second channel is defined by a first wall portion spaced from the transition and extending from the top plate and a second wall portion extending toward the transition and leaving a gap between the second wall portion and the transition.
